(19) United States
(12) Patent Application Publication
(10) Pub. No.: US 2014/0262951 A1
(43) Pub. Date: Sep. 18, 2014

(54) CLAY REMOVAL THROUGH SONICATION

(71) Applicant: PetroSonic Energy Inc., Calgary (CA)

(72) Inventors: Art AGOLLI, Calgary (CA); Patrick BRUNELLE, Langdon (CA); Alfred FISCHER, Calgary (CA)

(73) Assignee: PetroSonic Energy Inc., Calgary (CA)

(21) Appl. No.: 14/209,268

(22) Filed: Mar. 13, 2014

Related U.S. Application Data
(60) Provisional application No. 61/792,694, filed on Mar. 15, 2013.

(51) Int. Cl. C10G 32/00; B01J 19/10

(52) U.S. Cl. CPC C10G 32/00; B01J 19/10
USPC 208/177; 422/127

(57) ABSTRACT

The present disclosure refers to a method for clay removal using sonication treatment process for hydrocarbon recovery from a variety of mine pits or tailing ponds, to convert contaminated hydrocarbons substances into de-asphalted oil, heavy oil fuel or asphalt output. This method may generally require a solvent for removal of material in suspension, which may dissolve contaminated hydrocarbons by using a plurality of alkane containing non polar solvents, which may be filtered through simple separation. The sonication treatment process may reduce the production time of de-asphalted oil and heavy oil fuel, from a range from about six hours up to more than ten hours to about 5 seconds to 2 minutes depending on the solvent-feedstock mixture being processed.

### CROSS-REFERENCE TO RELATED APPLICATIONS

This application claims priority under 35 U.S.C. §119 to U.S. Provisional Patent Application Ser. No. 61/792,694, entitled “Clay Removal through Sonication,” filed Mar. 15, 2013, the entire contents of which are hereby incorporated herein by reference.

### BACKGROUND

1. Field of the disclosure

The present disclosure relates generally to clay removal from heavy oil and more particularly to a method for clay removal through sonication treatment process.

2. Background

A long recognized need exists for economical removal of clay for hydrocarbon recovery. A variety of methods have been proposed and attempted, but because of their high viscosity these hydrocarbons are difficult and expensive to recover. As the demand for oil has increased, commercial operations have expanded for recoveries of such heavy oil from clay contaminated areas, based on the fact that may be economically viable only when crude oil prices are high.

A number of methods have been developed for hydrocarbon recovery from clay contaminated areas, as well as for converting inferior grades of oil, into a more usable form for refineries or other uses.

Recent developments have greatly expanded these methods, by which clay may be removed from mine pits and tailing ponds for heavy oil recovery, are still evolving. Improvements in the operational efficiency of these methods may help to decrease cost for recovering heavy oils and may make economically viable.

One of the drawbacks from existing methods for removal of clay from hydrocarbons substances may be the complexity of methods employed, and high cost of processes.

For the forgoing reasons may be highly desirable to have a simple and cost effective method, for removal of clay and other contaminants from hydrocarbons substances, which may enable achieving higher performance for producing de-asphalted oil, heavy oil fuel and asphalt.

### SUMMARY

The present disclosure details a method for economical clay removal and hydrocarbon recovery from a variety of contaminated places, including but not limited to cleaning mine pits and tailing ponds.

According to one embodiment, implementation of the present disclosure may include test of materials, in order to determine a method for extraction based on the percentage of clay, hydrocarbons, and other materials, in order to select the extraction and transportation methods.

A heavy oil separator may be required to separate clay, hydrocarbon solids, sand and solid waste material, in preparation prior to using a proprietary sonic reactor to apply a sonic treatment process, which may include using a solvent to separate clay from hydrocarbon substances inside the chamber of sonic reactor.

According to one embodiment, this method may use a novel, simple, cost effective sonication treatment process for clay removal and hydrocarbon recovery, using a proprietary sonic reactor, the whole treatment system is portable, faster and scalable. Current technology may not be scalable, because was designed to work in very large refineries of a scale of about 50,000 barrels using tens of acres of land, while this equipment may be set up in as low of an acre of land.

Additionally, resident time during sonication and the selection of the most reactive solvent may make the process compact and smaller, which may be affordable for clay removal for small and medium producers currently facing high costs of heavy oil fuel.

The proprietary sonication treatment process may include the application of low-frequency, high-amplitude, high vibrational energy for an optimal mass transfer. The sonication treatment process may significantly reduce processing time from about 6 hours up to more than 10 hours to about 5 seconds to 2 minutes, depending on the solvent-feedstock mixture being processed.

Before sonication treatment of hydrocarbon substances, this method would generally require a solvent for removal of clay and other material in suspension. This solvent may be selected to ensure complete dissolution of oil-soluble components of bitumen.

This method may use solvent for clay removal through sonication process. The asphaltenes separation post sonication treatment may provide recovery results in a range of about 92% of the solvent or higher in the initial mix with heavy oil feedstock prior to sonic treatment, leaving a solvent residual in the oil within a range of about 4% to about less than 2%.

The solvent recovered may be reused and recycled with added new solvent for the continuous process of clay removal and production of DAO (de-asphalted oil), heavy oil fuel and asphalt.

This method may be easy to implement, having a cost efficient production costs for removal of clay and other contaminants from hydrocarbon substances.

In one embodiment, a method for clay removal and hydrocarbon recovery from contaminated hydrocarbons comprises: analyzing a percentage of the clay in the contaminated hydrocarbons in order to determine an extraction method based on the percentage of the clay in the contaminated hydrocarbons; extracting the contaminated hydrocarbons using the determined extraction method; removing clay equal to and exceeding a predetermined size from the contaminated hydrocarbons using a heavy oil separator; combining clay less than the predetermined size and remaining hydrocarbon substances of the contaminated hydrocarbons with a solvent in an in-line mixer to form a mixture; performing sonication on the mixture using a sonic reactor to separate the clay less than the predetermined size and asphaltenes from deasphalted oil in the mixture, wherein the deasphalted oil includes a first portion of the solvent and asphaltenes includes a second portion of the solvent; processing the deasphalted oil including the first portion of the solvent to recover the solvent from the deasphalted oil; and separating the clay less than the predetermined size and the second portion of the solvent from the asphaltenes.

In another embodiment, a clay removal system comprises: extraction equipment for extracting contaminated hydrocarbon substances; a heavy oil separator configured to receive the contaminated hydrocarbon substances and remove clay equal to or exceeding a predetermined size from the contaminated hydrocarbon substances; an in-line mixer configured to receive clay less than the predetermined size, remaining hydrocarbon substances of the contaminated hydrocarbons, and solvent and mix the clay less than the predetermined size, the remaining hydrocarbon substances of the contaminated hydrocarbons, and solvent to form a mixture; a sonicator configured to receive the mixture from the in-line mixer and apply a low-frequency, high-amplitude, high-vibrational energy to the mixture to separate the clay less than the predetermined size and asphaltenes from deasphalted oil in the mixture, wherein the deasphalted oil includes a first portion of the solvent and asphaltenes includes a second portion of the solvent; a first separator configured to receive the deasphalted oil including the first portion of the solvent and separate the solvent from the deasphalted oil to recover the solvent; and a second separator configured to receive clay less than the predetermined size, the asphaltenes, and the second portion of the solvent and separate the solvent and the clay less than the predetermined size from the asphaltenes.

In another embodiment, a method for clay removal and hydrocarbon recovery from contaminated hydrocarbons comprises: analyzing a percentage of the clay in the contaminated hydrocarbons in order to determine an extraction method based on the percentage of the clay in the contaminated hydrocarbons; extracting the contaminated hydrocarbons using the determined extraction method; removing clay equal to and exceeding a predetermined size from the contaminated hydrocarbons using a heavy oil separator; combining clay less than the predetermined size and remaining hydrocarbon substances of the contaminated hydrocarbons with a solvent in an in-line mixer to form a mixture; performing sonication on the mixture using a sonic reactor to separate the clay less than the predetermined size and asphaltenes from deasphalted oil in the mixture, wherein the deasphalted oil includes a first portion of the solvent and asphaltenes includes a second portion of the solvent; processing the deasphalted oil including the first portion of the solvent to recover the solvent from the deasphalted oil; recycling the solvent recovered from the deasphalted oil; separating the clay less than the predetermined size and the second portion of the solvent from the asphaltenes; and emulsifying the clay less than the predetermined size and the second portion of the solvent after separating the clay less than the predetermined size and the second portion of the solvent from the asphaltenes.

These and other advantages of the present disclosure may be evident to those skilled in the art, or may become evident upon reading the detailed description of this method, as shown in the accompanying process flow chart.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF DRAWING

A complete understanding of this method may be described in the present disclosure, and its various features, objects and advantages may be better understood from the illustration of the accompanying drawings, incorporated to illustrate and describe a method for clay removal and hydrocarbon recovery from a variety of mine pits or tailing ponds, using sonication treatment process.

FIG. 1 illustrates a flowchart process for clay removal from hydrocarbon substances, according to one embodiment.

FIG. 2A depicts a 3 view of sonicator, according to one embodiment.

FIG. 2B depicts a front view of sonicator, according to one embodiment.

FIG. 2C depicts a right plane section of sonicator, according to one embodiment.

FIG. 2D depicts a front plane section of sonicator, according to one embodiment.

### DETAILED DESCRIPTION

In the following detailed description, reference is made to the accompanying drawings, which form a part hereof. On these drawings, which are not to scale or to proportion, similar symbols typically identify similar components, unless context dictates otherwise. The illustrative embodiments described in the detailed description, are not meant to be limiting. Other embodiments may be used and other changes may be made without departing from the spirit or scope of the present disclosure.

### DEFINITIONS OF TERMS

All scientific and technical terms used in the present disclosure have meanings commonly used in the art, unless otherwise specified. The definitions provided here, are to facilitate understanding of certain terms used frequently and are not meant to limit the scope of the present disclosure.

“Sonication” may refer to any device or system which produces vibrational energy sufficient to impact one or more desired end uses.

“Asphaltenes” may refer to materials, present in heavy oils and bitumen's, which precipitate in n-alkanes solvent.

### DESCRIPTION OF THE DRAWING

### Method for Clay Removal Through Sonication Process

FIG. 1 illustrates a simplified flowchart process for clay removal structure 100, incorporating a method for clay removal from a variety of contaminated places, including but not limited to cleaning mine pits and tailing ponds.

The present disclosure may initiate a process for clay removal by analyzing content of clay in contaminated hydrocarbons step 102, which may include test of mixture of materials, in order to determine a proper method for extraction based on the percentage of clay, hydrocarbons and other materials in order to select the equipment suitable for extraction and test of materials step 104. Based on type of material, extraction may employ pumps, excavator diggers, conveyors, shovels, and the like.

Extracted material may require transportation to site step 106, according to percentage of solid material may use dump trucks, pipe lines, conveyors or any suitable transportation capable to haul heavy materials to site, for separation of clay exceeding 100 μm, as well as any other solid hydrocarbon materials using a heavy oil separator step 108. All removed material may be sent to waste or solid handling boilers step 110.

Remaining hydrocarbon substances and particles of clay less than 100 μm may require using a plurality of alkane containing non polar solvents such as n-alkane in an appropriated ratio for in-line mixer step 112 which may precipitate heavy oil feedstock to be processed by sonication treatment step 114. Solvent ratios may be determined from the level of clay and other materials contained in selected contaminated hydrocarbons step 102, desired level of separation of DAO and heavy oil fuel and cost factors associated with clay removal structure 100.

Hydrocarbon substances and particles of clay less than 100 μm, may be statically or dynamically combined with selected solvent, to form a stable and optimized mixture employing an in-line mixer for proper blending and homogenization, which may be required for efficient sonication treatment step 114 employing a proprietary sonic reactor, or sonicator, using a low-frequency/high vibrational energy/high-amplitude sonic reactor, to separate micro solid clay materials from mixture, mainly achieved as a result of de-asphalting.

Vibration energy of the cleaning process by sonication treatment step 114, may cause micro suspended solids in the fluid to go into solution, along with asphalting may conglomerate out, which may allow for significant improvement in the mass transfer efficiency of de-asphalted hydrocarbons and residues of solvents, which may be routed to DAO asphaltenes separator step 116.

Subsequently asphaltenes+impurities+solvent step 118 may be directed to asphaltene conversion step 120, for process of second separation of materials. From one side may direct asphaltenes to asphalt market step 122 and from the other side may direct remaining impurities and solvent to emulsification step 124 for emulsification process, which may be sent to heavy oil fuel market step 126, to make it available to refineries or other heavy oil markets.

DAO asphaltenes separator step 116 also may send DAO solvent step 128, for subsequently separation of DAO and solvent on DAO extraction step 130, after removal of DAO may be send to DAO market step 132. The solvent recovered may be reused and recycled with added new solvent for the continuous clay removal and production of DAO after DAO extraction step 130, remaining solvent may be routed to solvent recovery step 134, which may be returned to in-line mixer step 112 along with solvent forthcoming from make up solvent tank step 136.

The foregoing sonication treatment process may significantly reduce de-asphalting processing time, from a range of 6 hours to about 10+hours to a range from about 5 seconds to 2 minutes

### Sonic Reactor Operation

FIG. 2A depicts a 3D view 202, in FIG. 2B shows a front view 204, in FIG. 2C shows right plane section 206, and in FIG. 2D shows front plane section 208. sonic reactor 200 is shown having support structure 210, resonant bar 212, and a set of magnet configuration 214, resonant bar supports 216, and reaction chamber 218 on each end of resonant bar 212.

Sonic reactor 200 may use support structure 210 to hold resonant bar 212 in place using any suitable support as resonant bar supports 216. Suitable configurations for resonant bar supports 216 may include configurations including three or more rubber air cushions. Any suitable magnet configuration 214, activated by a control module (not shown), may cause resonant bar 212 to vibrate, sonicating to heavy oil feedstock in one or more reaction chamber 218. Suitable configurations for magnet configuration 214 include configurations with at least 3 magnets and power suitable to cause resonant bar 212 to vibrate.

Heavy oil feedstock in reaction chamber 218 may have previously been chemically altered to allow the upgrading of heavy oil feedstock in reaction chamber 218, methods for preparation may include using a plurality of alkane containing non polar solvents such as n-alkane.

The period of time needed to upgrade heavy oil feedstock in reaction chamber 218 may vary in dependence with a number of factors, including the amplitude and frequency of the vibration of resonant bar 212. The amplitude and frequency of the vibration of resonant bar 212 may in turn depend on the mass of resonant bar 212 and the mass of reaction chamber 218.

While various aspects of this method may be described in the present disclosure, other aspects and embodiments may be contemplated. The various aspects and embodiments disclosed here are for purpose of illustration, and are not intended to be limiting with the scope and spirit being indicated by the following claims.

The embodiments described above are intended to be exemplary. One skilled in the art recognizes that numerous alternative components and embodiments that may be substituted for the particular examples described herein and still fall within the scope of the invention.

What is claimed is:

1. A method for clay removal and hydrocarbon recovery from contaminated hydrocarbons comprising:
analyzing a percentage of the clay in the contaminated hydrocarbons in order to determine an extraction method based on the percentage of the clay in the contaminated hydrocarbons;
extracting the contaminated hydrocarbons using the determined extraction method;
removing clay equal to and exceeding a predetermined size from the contaminated hydrocarbons using a heavy oil separator;
combining clay less than the predetermined size and remaining hydrocarbon substances of the contaminated hydrocarbons with a solvent in an in-line mixer to form a mixture;
performing sonication on the mixture using a sonic reactor to separate the clay less than the predetermined size and asphaltenes from deasphalted oil in the mixture, wherein the deasphalted oil includes a first portion of the solvent and asphaltenes includes a second portion of the solvent;
processing the deasphalted oil including the first portion of the solvent to recover the solvent from the deasphalted oil; and
separating the clay less than the predetermined size and the second portion of the solvent from the asphaltenes.

2. The method of claim 1, wherein the extraction method determines the equipment used to extract the contaminated hydrocarbon substances.

3. The method of claim 1, further comprising:
transporting the contaminated hydrocarbons to a clay removal site after the contaminated hydrocarbons have been extracted using the determined extraction method.

4. The method of claim 3, wherein the contaminated hydrocarbons are transported using a dump truck, a pipe line, or a conveyor.

5. The method of claim 1, wherein the predetermined size is 100 μm.

6. The method of claim 1, wherein the solvent is an alkane containing non-polar solvent.

7. The method of claim 1, wherein a ratio of solvent to be mixed with the clay less than the predetermined size and remaining hydrocarbon substances is determined based on the percentage of clay in the contaminated hydrocarbons.

8. The method of claim 1, wherein a ratio of solvent to be mixed with the clay less than the predetermined size and remaining hydrocarbon substances is determined based on a predetermined level of separation of deasphalted oil and heavy oil fuel.

9. The method of claim 1, further comprising:
recycling the solvent recovered from the deasphalted oil.

10. The method of claim 1, further comprising
emulsifying the clay less than the predetermined size and the second portion of the solvent after separating the clay less than the predetermined size and the second portion of the solvent from the asphaltenes.

11. A clay removal system comprising:
extraction equipment for extracting contaminated hydrocarbon substances;
a heavy oil separator configured to receive the contaminated hydrocarbon substances and remove clay equal to or exceeding a predetermined size from the contaminated hydrocarbon substances;
an in-line mixer configured to receive clay less than the predetermined size, remaining hydrocarbon substances of the contaminated hydrocarbons, and solvent and mix the clay less than the predetermined size, the remaining hydrocarbon substances of the contaminated hydrocarbons, and solvent to form a mixture;
a sonicator configured to receive the mixture from the in-line mixer and apply a low-frequency, high-amplitude, high-vibrational energy to the mixture to separate the clay less than the predetermined size and asphaltenes from deasphalted oil in the mixture, wherein the deasphalted oil includes a first portion of the solvent and asphaltenes includes a second portion of the solvent;
a first separator configured to receive the deasphalted oil including the first portion of the solvent and separate the solvent from the deasphalted oil to recover the solvent; and
a second separator configured to receive clay less than the predetermined size, the asphaltenes, and the second portion of the solvent and separate the solvent and the clay less than the predetermined size from the asphaltenes.

12. The clay removal system of claim 11, further comprising:
a make-up solvent tank configured to add more solvent to recovered solvent when the recovered solvent is recycled.

13. The clay removal system of claim 11, further comprising:
a dump truck, a pipe line, or a conveyor configured to transport the contaminated hydrocarbon substances to the heavy oil separator.

14. The clay removal system of claim 11, wherein the predetermined size is 100 μm.

15. The clay removal system of claim 11, wherein the solvent is an alkane containing non-polar solvent.

16. The clay removal system of claim 11, wherein the extraction equipment comprises at least one from the group consisting of a pump, excavator diggers, conveyors, and shovels.

17. The clay removal system of claim 11, further comprising:
testing equipment configured to analyze a percentage of clay in the contaminated hydrocarbon substances.

18. The clay removal system of claim 17, wherein an extraction method performed by the extraction equipment is determined based on the percentage of clay in the contaminated hydrocarbon substances.

19. A method for clay removal and hydrocarbon recovery from contaminated hydrocarbons comprising:
analyzing a percentage of the clay in the contaminated hydrocarbons in order to determine an extraction method based on the percentage of the clay in the contaminated hydrocarbons;
extracting the contaminated hydrocarbons using the determined extraction method;
removing clay equal to and exceeding a predetermined size from the contaminated hydrocarbons using a heavy oil separator;
combining clay less than the predetermined size and remaining hydrocarbon substances of the contaminated hydrocarbons with a solvent in an in-line mixer to form a mixture;
performing sonication on the mixture using a sonic reactor to separate the clay less than the predetermined size and asphaltenes from deasphalted oil in the mixture, wherein the deasphalted oil includes a first portion of the solvent and asphaltenes includes a second portion of the solvent;
processing the deasphalted oil including the first portion of the solvent to recover the solvent from the deasphalted oil;
recycling the solvent recovered from the deasphalted oil;
separating the clay less than the predetermined size and the second portion of the solvent from the asphaltenes; and
emulsifying the clay less than the predetermined size and the second portion of the solvent after separating the clay less than the predetermined size and the second portion of the solvent from the asphaltenes.
